(19) United States
(12) Patent Application Publication
(10) Pub. No.: US 2009/0082019 A1
(43) Pub. Date: Mar. 26, 2009

(54) METHODS, SYSTEMS, AND COMPUTER READABLE MEDIA FOR PROVIDING DYNAMIC ROAMING ARBITRAGE SERVICE

(76) Inventor: Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/192,737

(22) Filed: Aug. 15, 2008

Related U.S. Application Data
(60) Provisional application No. 60/995,106, filed on Sep. 24, 2007.

(51) Int. Cl. H04W 60/00; H04W 4/00

(52) U.S. Cl. 455/435.2

(57) ABSTRACT

Methods, systems, and computer readable media for providing dynamic roaming arbitrage service are disclosed. The method includes receiving a signaling message associated with a mobile subscriber, wherein the signaling message is addressed to a mobile services node for one of mobility management, registration, and authentication of the mobile subscriber. In response to receiving the signaling message, an auction is initiated for the right to provide roaming service to the mobile subscriber. Network selection information is communicated to the mobile subscriber based on the results of the auction.

### RELATED APPLICATIONS

The present application claims the benefit of U.S. Provisional Patent Application Ser. No. 60/995,106, filed Sep. 24, 2007, the disclosure of which is incorporated herein by reference in its entirety.

### TECHNICAL FIELD

The subject matter described herein relates to roaming service in a mobile communications network. More particularly, the subject matter described herein relates to methods, systems, and computer readable media for providing dynamic roaming arbitrage service.

### BACKGROUND

In mobile communications networks, communication service subscribers may be associated with a “home” network, which may be identified as the network containing a home location register (HLR) or home subscriber server (HSS) entry for the subscriber. The home network for a particular subscriber is typically owned or operated by a network operator that recruited the subscriber and when the subscriber is operating within his or her home network, the subscriber's mobile handset communicates with one or more base stations located in a home geographic coverage area. While many network operators' home coverage areas are large, there may still be areas in which the subscriber cannot connect to a home network base station. In such cases, the subscriber may connect to a base station belonging to another operator's network. When a subscriber obtains mobile or wireless service in a network other than his or her home network, the subscriber may be said to be “roaming.” Thus, all networks, other than the home network, may be considered “visited” or “roaming” networks.

When roaming, a subscriber's handset may determine which visited network to connect to by consulting a preferred network selection list stored at the subscriber's mobile handset. A network selection list typically includes a prioritized listing of one or more roaming service providers where a most preferred network will be connected to before a less preferred network, assuming all other conditions are equal. Additional criteria may be used in determining the roaming network to connect to. For example, the signal strength of each base station within range of the user's mobile handset may be taken into account when determining whether to connect to a particular network when roaming. For example, a subscriber's handset may initially attempt to connect to the most preferred roaming network when the subscriber is outside of the “home” network. However, if the most preferred roaming network is unavailable or a quality of service (QoS) parameter (e.g., signal strength) is too poor, then a connection to the next most preferred roaming network may be attempted.

There are several ways to populate and/or update a network selection list stored on a subscriber's mobile handset. For example, if the mobile handset is connected to the “home” network, then the home network operator may transmit, without a request, network selection list updates to the handset via an Over-The-Air (OTA) interface. This is referred to as “pushing” network selection list updates to the mobile subscriber.

Alternatively, if the handset is connected to a visited network (i.e. “roaming”), the home operator may “push” network selection list updates to the handset using either an Unstructured Supplementary Service Data (USSD) message or a short message service (SMS) message. Like SMS, USSD facilitates the communication of a short text string through the network. However, rather than displaying the received message on the handset's display, an application located on the subscriber's handset may be configured to recognize an SMS or USSD message containing the network selection list update and update the network selection list stored on the handset accordingly.

Determination of networks to be included in a network selection list and timing of network selection list updates may be made according to a variety of factors. In one example, “blanket” roaming partnerships may be negotiated by network operators, where it is agreed that customers belonging to a first network will preferably connect to a second network when roaming. For example, Verizon Wireless may negotiate a blanket roaming agreement with Vodafone, such that Verizon Wireless subscribers that are roaming outside of Verizon's home network will preferentially connect to a Vodafone network when given the opportunity. If the Vodafone agreement lapses or is replaced by an agreement with another roaming partner, then an updated network selection list may be pushed to Verizon Wireless subscribers using one of the methods described above.

One problem associated with conventional methods and systems for populating, prioritizing, and updating network selection lists is that it is difficult for mobile subscribers, or their home service provider, to select the best rate from among multiple roaming service providers. Often, roaming mobile subscribers are subject to blanket roaming agreements between their home service provider and other roaming network operators which limit the ability to dynamically select one or more roaming service providers offering the lowest price at the time a call is made or for the particular calling patterns of that subscriber.

Accordingly, there exists a need for methods, systems, and computer readable media for providing dynamic roaming arbitrage service.

### SUMMARY

The subject matter described herein includes a method for providing dynamic roaming arbitrage. According to one embodiment, the method includes receiving a signaling message associated with a mobile subscriber, wherein the signaling message is addressed to a mobile services node for one of mobility management, registration, and authentication of the mobile subscriber. In response to receiving the signaling message, an auction is initiated (e.g., amongst potential roaming network operators) for the right to provide roaming service to the mobile subscriber. Network selection information is communicated to the mobile subscriber based on the results of the auction.

According to another aspect, a signaling message associated with a mobile subscriber is received and it is determined whether the mobile subscriber is roaming based on the signaling message. In response to determining that the mobile subscriber is roaming, network selection information is determined based on an auction among one or more roaming service providers.

According to another aspect, the method includes receiving one or more bids for the right to provide roaming service to the mobile subscriber and automatically determining network selection information based on the received signaling message and the one or more bids.

According to yet another aspect, the subject matter described herein includes a system for providing dynamic roaming arbitrage service. A roaming screening module (RSM) receives, at a mobile services node (e.g., HLR, HSS, MSC, SIP Proxy, IP Multimedia Subsystem Call Session Control Function (CSCF), etc.), a signaling message associated with a mobile subscriber, wherein the signaling message is addressed to a mobile services node for one of mobility management, registration, and authentication of the mobile subscriber. In response to receiving the signaling message, a roaming arbitrage exchange (RAE) module initiates an auction for the right to provide roaming service to the mobile subscriber based on the received message and communicates network selection information to the mobile subscriber based on the results of the auction.

According to yet another aspect, a roaming screening module (RSM) intercepts, at an intermediate node, a signaling message associated with a mobile subscriber, wherein the signaling message is addressed to a mobile services node for one of mobility management, registration, and authentication of the mobile subscriber. Exemplary intermediate nodes include a Signaling System 7 (SS7) signal transfer point, a signaling gateway, a SIP router, a SIP proxy server, a network monitoring system, or a stand-alone RSM intercept platform. A roaming arbitrage exchange (RAE) module initiates an auction for the right to provide roaming service to the mobile subscriber based on the intercepted message and communicates network selection information to the mobile based on the results of the auction.

According to yet another aspect, a roaming screening module (RSM) intercepting, at an intermediate signaling node, a signaling message associated with a mobile subscriber. A roaming arbitrage exchange (RAE) module receives one or more bids for the right to provide roaming service to the mobile subscriber and automatically determines network selection information based on the intercepted signaling message and the one or more bids.

The subject matter described herein for providing dynamic roaming arbitrage service may be implemented using a computer readable medium comprising instructions that when executed by a processor perform steps. Exemplary computer readable media suitable for implementing the subject matter described herein includes disk memory devices, programmable logic devices, and application specific integrated circuits. In one implementation, the computer readable medium may include a memory accessible by a processor. The memory may include instructions executable by the processor for implementing any of the methods described herein. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a network diagram of an exemplary GSM network including an integrated roaming screening module for providing dynamic roaming arbitrage service according to an embodiment of the subject matter described herein;

FIG. 2 is a network diagram of an exemplary GSM network including an probe-based roaming screening module for providing dynamic roaming arbitrage service according to an embodiment of the subject matter described herein;

FIG. 3 is a network diagram of an exemplary IEEE 802.xx network including an integrated roaming screening module for providing dynamic roaming arbitrage service according to an embodiment of the subject matter described herein;

FIG. 4 is a network diagram of an exemplary SIP network including an integrated roaming screening module for providing dynamic roaming arbitrage service according to an embodiment of the subject matter described herein; and

FIG. 5 is a flow chart of exemplary steps for providing dynamic roaming arbitrage service according to an embodiment of the subject matter described herein.

### DETAILED DESCRIPTION

In view of the problems described above with respect to providing roaming service in a mobile communications network, the subject matter described herein provides for providing dynamic roaming arbitrage service. Where previously conventional systems provided for updating preferred roaming network selection lists based on changes to roaming agreements between providers, resulting in overpayment and/or less flexible selection of roaming services, the subject matter described herein provides for initiating, on a per subscriber basis, an auction for the right to provide roaming services for the mobile subscriber. By providing dynamic roaming arbitrage service, a home network operator may achieve cheaper and more flexible roaming services for its mobile subscribers that are roaming. Dynamic roaming arbitrage may be implemented in a mobile communications network, as will be described in more detail below.

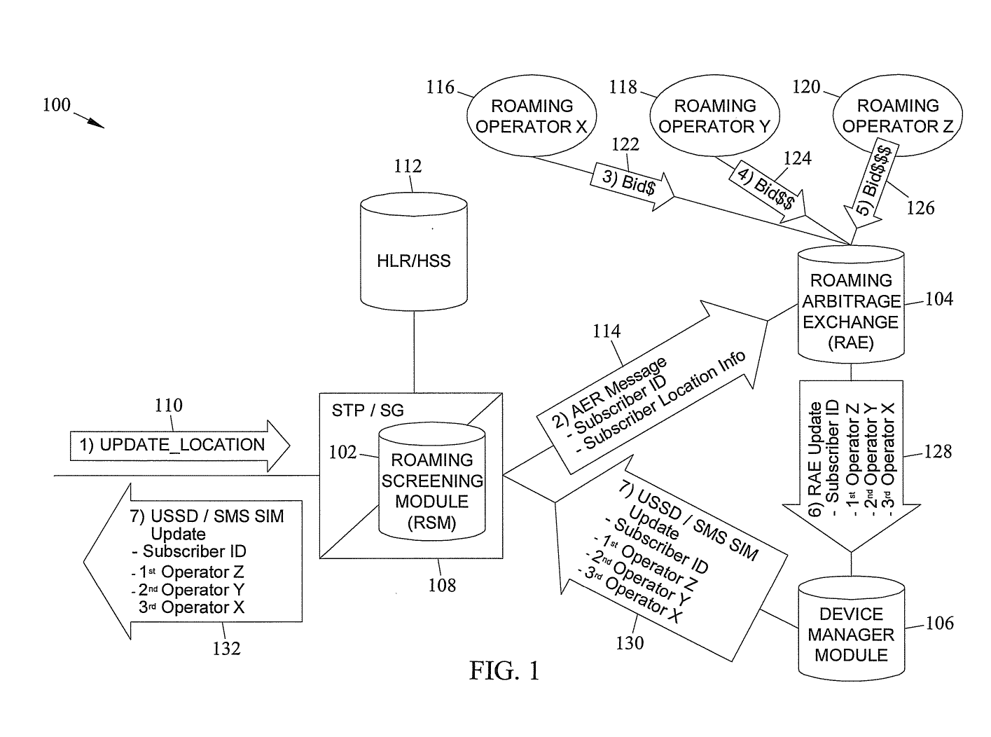

FIG. 1 is a network diagram of an exemplary GSM network including an integrated roaming screening module for providing dynamic roaming arbitrage service according to an embodiment of the subject matter described herein. Referring to FIG. 1, exemplary GSM network 100 may include a roaming screening module (RSM) 102, a roaming arbitrage exchange (RAE) module 104, and a device manager module (DMM) 106. Collectively, modules 102-106 may perform dynamic roaming exchange arbitrage. As will be described in greater detail below, in one embodiment, RSM 102 may receive a signaling message associated with a mobile subscriber, and in response RAE 104 may initiate an auction for the right to provide roaming service to the mobile subscriber, and DMM 106 may communicate network selection information to the mobile subscriber based on the results of the auction.

In the embodiment illustrated in FIG. 1, RSM 102 may be co-located and/or integrated with a communications network signaling node for intercepting a signaling message associated with a mobile subscriber. For example, RSM 102 may be located at signal transfer point (STP)/signaling gateway (SG) 108. Therefore, when a mobile subscriber (not shown) connects to visited network 100 (i.e. the subscriber is roaming), a mobile application part (MAP) Update_Location message may be generated by a MSC/VLR and sent to a mobile services node for one of mobility management, registration, and authentication of the mobile subscriber. However, unlike conventional systems, the signaling message may first be intercepted by RSM 102 and used to generate an Arbitrage Exchange Registration (AER) message for initiating an auction for the right to provide roaming service to the subscriber. For example, Update_Location message 110 addressed to HLR/HSS 112 may be received (or intercepted) by RSM 102 co-located with STP/SG 108.

After receiving message 110, RSM 102 may extract one or more message parameters to be included in AER message 114. For example, RSM 102 may examine Update_Location message 110 and extract one or more of an international mobile subscriber identity (IMSI) parameter value, a mobile switching center (MSC) address parameter value, a visitor location register (VLR) number parameter value or other mobile subscriber identifier. It is appreciated that RSM 102 may determine whether the extracted parameter(s) are associated with an MSC belonging to the home network. For example, RSM 102 may include, or have access to, a database which associates an IMSI value with a mobile subscriber integrated services digital network (MSISDN) value. In other examples, multiple MSISDN values may be associated with a single IMSI. Additionally, RSM 102 may include, or have access to, a database that identifies whether an MSC address is associated with a home MSC, identifies a network operator associated with an MSC address, or a combination of the two. In this example, if RSM 102 determines that the MSC address parameter value is not associated with an MSC belonging to the home network, RSM 102 may generate Arbitrage Exchange Registration (AER) message 114.

As stated above, AER message 114 may contain information identifying the mobile subscriber, such as an IMSI, an MSISDN, or a temporary ID that uniquely identifies the subscriber. If the subscriber information is a temporary ID, the temporary ID may be associated with the subscriber IMSI or MSISDN and a record of this association may be generated by the RSM 102. Additionally, AER message 114 may include information that indicates a location of the roaming subscriber. In one embodiment, RSM 102 may include, or have access to, a database associating location information with an MSC address and/or VLR number. In another embodiment, RSM 102 extract mobile subscriber location information (e.g., GPS coordinates) directly from a received/intercepted signaling message, or may be adapted to query a mobile services node to obtain location information associated with the mobile subscriber. Thus, AER message 114 may include physical location coordinates associated with the roaming subscriber.

In another embodiment, RSM 102 may include, or have access to, a database that associates one or more of a network operator, a network identifier, a sub-network identifier, a geographic cell, and a region identifier with an MSC address and/or VLR number. Thus, AER message 114 may include an identifier that provides a more general indication of the roaming subscriber's location.

In yet another embodiment, RSM 102 may request location information from the serving MSC via a MAP_Provide_Subscriber_Location message. The serving MSC may respond to the RSM request be generating a MAP_Subscriber_Location_Report message, which includes location information associated with the mobile subscriber. RSM 102 may then extract location info from the MAP message and include the location information in AER message 114. It is appreciated that in addition to the subscriber information described above, other information may be obtained by RSM 102 from other network elements and included in AER message 114. For example, information indicating past communication network usage habits of the mobile subscriber may be obtained by RSM 102 and included in AER message 114. Such network usage habit information may be useful to potential roaming service provider bidders. For example, a roaming service provider may be willing to bid a higher amount for the opportunity to provide roaming service to a mobile subscriber that has historically been a heavy user of certain network services (e.g., voice call services, messaging services, data services, etc.).

After generating and transmitting AER message 114 to RAE module 104, RSM 102 may continue to monitor the status of the mobile subscriber and periodically generate Arbitrage Exchange Update (AEU) messages that may provide roaming and/or network status of the mobile subscriber to RAE module 104.

RAE module 104 may receive AER message 114 and initiate an auction for the right to provide roaming services to the mobile subscriber from among multiple roaming service providers. A roaming service provider may include, for example, a mobile network operator (MNO) or a mobile virtual network operator (MVNO). A MNO is a company providing mobile communications services, where an MNO is characterized by owning its communications infrastructure and licensing a portion of the radio frequency spectrum directly from the federal government. In contrast, a MVNO typically owns little or no mobile communications infrastructure and purchases wholesale allotments of time from other providers in order to provide mobile service to subscribers. Because MVNOs and MNOs may operate independently, they often have different price structures for the mobile services they provide.

An auction initiated by RAE module 104 may begin by posting the mobile subscriber for “auction,” establishing an auction timer, and setting a minimum bid for the auction. RAE module 104 may also provide an electronic interface for roaming service providers wishing to participate in an auction. Through this electronic interface, one or more of roaming service providers 116-120 may tender a bid for the right to provide roaming services to the mobile subscriber until the auction timer expires. In one embodiment, roaming service provider 116 may tender bid 122, roaming service provider 118 may tender bid 124, and roaming service provider 120 may tender bid 126, where bid 122 is the lowest bid and bid 126 is the highest bid. Each of the bids tendered by roaming service providers 116-120 in this example may also specify a minimum or maximum time for which they are willing to provide roaming service to the mobile subscriber at the bid price. Alternatively, the home network operator may specify the maximum time that the winning bidder is permitted to provide roaming service to the mobile subscriber before the mobile subscriber's roaming service is re-auctioned.

Once the auction/bidding period expires, RAE module 104 may analyze the tendered bids and prioritize the results. In one embodiment, a preferred roaming network selection list may be prepared by RAE module 104, where the network selection list indicates that roaming operator 116 is the most preferred roaming network, roaming operator 118 is the second most preferred, and roaming operator 120 is the least preferred roaming network. As stated above, the most preferred roaming operator is associated with the best bid in the auction. However, the determination of what constitutes the best bid may be performed by RAE module 104, and may not necessarily correspond with simply the lowest price. RAE module 104 may use any number of algorithms to determine what constitutes the best/worst bids. As such, the preferred roaming network selection list may include a single, most preferred MNO/MVNO entry or a continuum of MNO/MVNO entries from most preferred to least preferred.

It is further appreciated that multiple auctions may be performed for a single mobile subscriber when multiple services may be provided to the roaming mobile subscriber. For example, a first auction may be held for the right to provide voice service to the roaming mobile subscriber, a second auction may be held for the right to provide general packet radio service (GPRS) service to the roaming mobile subscriber, a third auction may be held for the right to provide messaging service to the roaming subscriber, and a fourth auction may be held for the right to provide IMS/SIP service to the roaming subscriber, fifth auction may be held for the right to provide 2G cellular service (e.g., GSM, IS41, etc.) to the roaming subscriber etc. These auctions may result in a first most preferred MNO/MVNO for voice roaming service, and a second most preferred MNO/MVNO for GPRS roaming service. In the event that multiple auctions are held for a single mobile subscriber, multiple preferred network selection lists may be produced by RAE module 104 corresponding to each auction/service type or, alternatively, a single list may be generated where each entry in the list may be associated with a service type.

According to another aspect, RAE module 104 may initiate and host multiple auctions for a single mobile subscriber over a period of time, including hosting repeated auctions for the same service(s). For example, RAE module 104 may monitor the duration of service committed to in a previous auction for a mobile subscriber and automatically re-auction the roaming service rights when that contract expires. In other embodiments, RAE module 104 may determine whether re-auctioning is required based on Arbitrage Exchange Update (AEU) message(s) received from RSM 102 and associated with the same mobile subscriber.

According to yet another aspect, a home network operator may provide additional information associated with a roaming subscriber to a potential arbitrage bidder. For example, the home network operator may conditionally provide a potential bidder with network service usage statistics associated with the roaming subscriber for an additional fee. Exemplary network service usage statistics provided to a potential bidder may include an average number of calls placed while roaming, an average number of calls placed wile connected to the home network, an average duration of calls placed while roaming, an average duration of calls placed in the home network, an average duration for GPRS sessions while roaming/in home network, an average GPRS bandwidth use while roaming/in home network, messaging service usage statistics, IMS/SIP network usage statistics, mobile device/device capabilities information and any other network statistics potentially useful to a bidder of roaming services. In this manner, a bidder may use the additional network usage statistics when formulating a bid for submission to RAE module 104 during an auction period.

Upon determining a preferred roaming network selection list 128, RAE module 104 may be configured to provide roaming network selection list 128, along with any additional mobile subscriber identification information as described above, to device manager module (DMM) 106 for delivery to the handset of the mobile subscriber. Device manager module 106 may format preferred roaming network selection information 128 into network selection list 130 and send it to the mobile subscriber's handset via one of SMS, USSD, OTA, simple object access protocol (SOAP), XML or another suitable method. For example, in a 2G cellular embodiment, DMM 106 may formulate an application-type USSD message 130 that includes a list of preferred roaming networks and transmit USSD message 130 to the mobile subscriber's handset via STP/SG 108. Upon receiving network selection list 130, an application at the mobile subscriber's handset may automatically recognize message 130 as an application-type USSD message and update the network selection list accordingly.

In an alternate embodiment, device manager module 106 may be integrated with RSM 102 without departing from the scope of the subject matter described herein. It is further appreciated that in addition to the embodiment illustrated in FIG. 1, RSM 102, RAE 104, and DMM 106 may be integrated, co-located, or otherwise combined with any suitable communications node, including but not limited to STP/SG 108, without departing from the scope of the subject matter described herein.

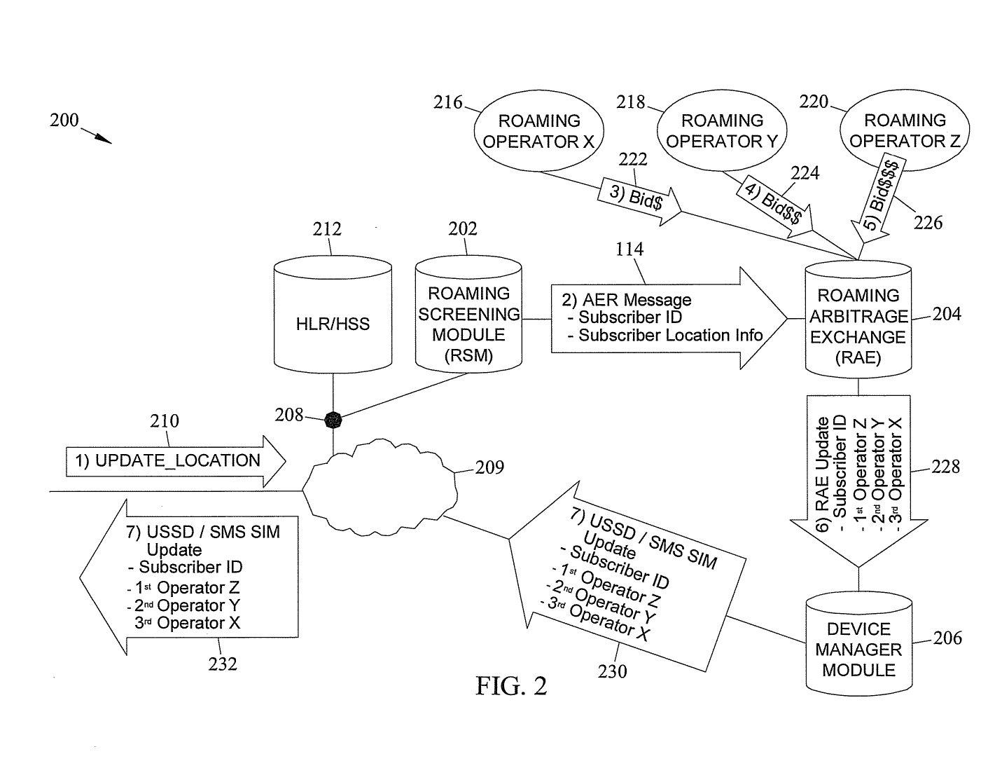

FIG. 2 is a network diagram of an exemplary GSM network including a probe-based roaming screening module for providing dynamic roaming arbitrage service according to an embodiment of the subject matter described herein. Referring to FIG. 2, exemplary GSM network 200 may include RSM 202 operatively connected to probe 208 for examining signaling messages within network 200. For example, Update_Location message 210 may be associated with a roaming mobile subscriber (not shown) that is addressed to HLR/HSS 212. RSM 202 may be configured to intercept or copy message 210 at probe 208 en route to HLR/HSS 212. Based on the subscriber location information included in message 210, as well as other information available to RSM 202, RSM 202 may generate and send AER message 214 to RAE 104 for initiating an auction for the right to provide roaming services to the mobile subscriber.

Upon receiving AER message 214, RAE module 204 may communicate with roaming operators 116-120 for hosting one or more auctions, where bids may be received from operators 216-220 during the auction period. Bids 222-226 may be evaluated by RAE module 204 and a network selection list 228 may be determined. As described above, network selection list 228 may prioritize (or otherwise order) networks 216-220 based on bids 222-226. In FIG. 2, network selection list 228 indicates that operator 220 is the most preferred network, operator 218 is the next most preferred network, and operator 216 is the least preferred network. Network selection list 228 may then be sent to DMM 206 for delivery to the mobile subscriber's handset. For example, DMM 206 may generate and send USSD/SMS message 230 to the mobile subscriber via network 209.

As described above with respect to FIG. 1, it is appreciated that device manager module 206 may be integrated with RSM 202 without departing from the scope of the subject matter described herein. It is further appreciated that in addition to the embodiment illustrated in FIG. 1, RSM 202, RAE 204, and DMM 206 may be integrated, co-located, or otherwise combined without departing from the scope of the subject matter described herein.

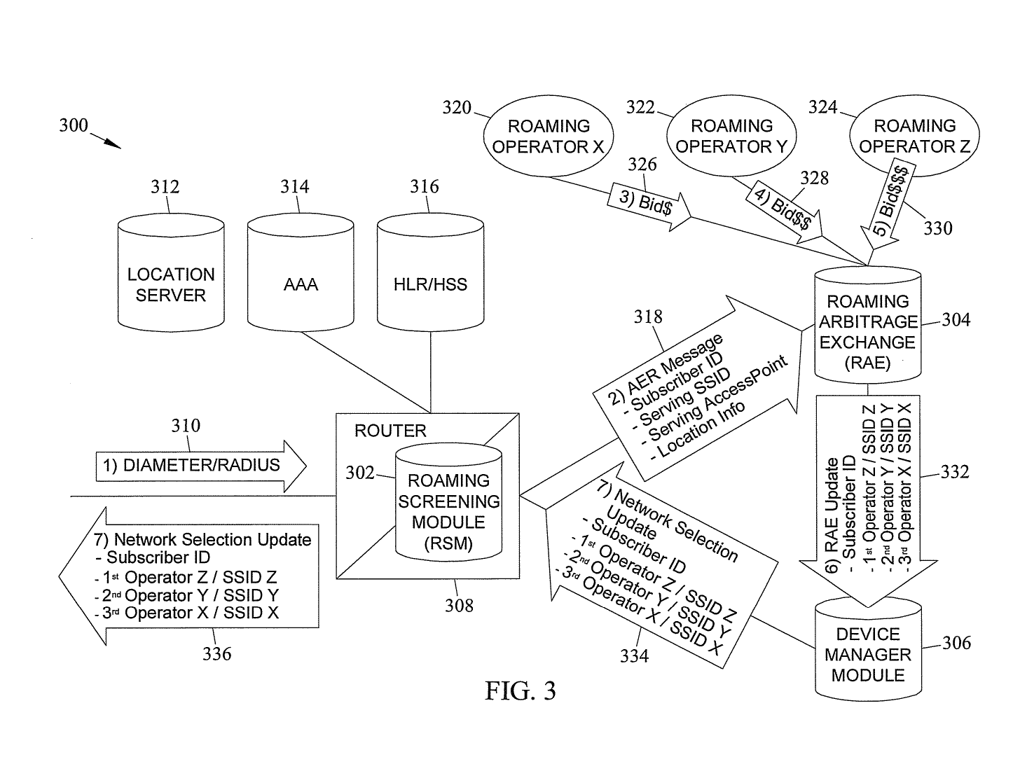

FIG. 3 is a network diagram of an exemplary 802.xx network including an integrated roaming screening module for providing dynamic roaming arbitrage service according to an embodiment of the subject matter described herein. For example, network 300 may include a WiFi or a WiMAX network, where a WiFi network is an 802.11x network for wireless communications at short ranges (i.e. typically less than 100 meters), and where a worldwide interoperability for microwave communications (WIMAX) network is an 802.16 network for providing long range wireless telecommunications services (i.e. typically several kilometers). In the embodiment shown in FIG. 3, a Radius, DIAMETER, or SIP message may be used to authenticate and/or register a mobile subscriber in a network and may be intercepted by RSM 302 for generating AER message 318. It is appreciated that router 308 may be connected to one or more of HLR/HSS 316, authentication, authorization, accounting (AAA) database 314, and location server 312. Thus, DIAMETER/Radius/SIP message 310 intercepted by RSM 302 may be addressed to one or more of databases 312-316.

Upon receiving AER message 318, in one embodiment, RAE module 304 may also be configured to communicate with roaming operators 320-324 for hosting one or more auctions, where bids may be received from operators 320-324 during the auction period. Bids 326-330 may be evaluated by RAE module 304 and network selection list information 332 may be determined. As described above, network selection list information 332 may prioritize (or otherwise order) networks 320-324 based on bids 326-330. In FIG. 3, network selection list information 332 indicates that operator 324 is the most preferred network, operator 322 is the next most preferred network, and operator 320 is the least preferred network. Network selection list information 332 may then be sent to DMM 306 for delivery to the mobile subscriber's handset. For example, DMM 306 may generate and send update message 334 to the mobile subscriber.

As stated with respect to FIGS. 1 and 2 above, methods for providing dynamic roaming arbitrage service may be implemented in integrated or probe-based embodiments without departing from the scope of the subject matter described herein. Also, RSM 302 may infer general location information from triggering authentication/registration messages, such as message 310, or may obtain location information associated with a mobile subscriber. For example, RSM 302 may query a location server, query an HSS, query an HLR, or directly query the mobile subscriber handset. RSM 302 may also obtain subscriber service profile information via, for example, an HSS/HLR query. Some or all of this information may be communicated to RAE module 304 for initiating and hosting an auction for the right to provide roaming service to the mobile subscriber from among one or more roaming service providers 320-324. For example, in WiFi/WiMax network 300, a preferred network identifier, such as a SSID, may be pushed to the mobile subscriber's device via XML, SOAP, USSD or other communication protocol from DMM 306.

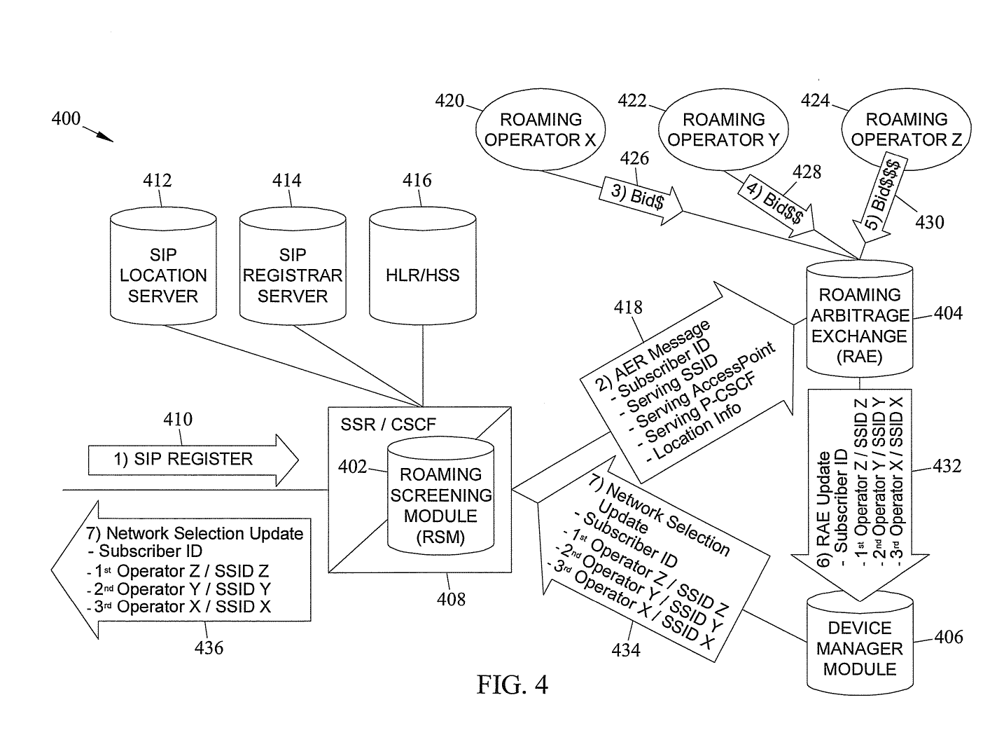

FIG. 4 is a network diagram of an exemplary SIP network including an integrated roaming screening module for providing dynamic roaming arbitrage service according to an embodiment of the subject matter described herein. For example, network 400 may include a WiFi or a WiMAX network, where a WiFi network is an 802.11x network for wireless communications at short ranges (i.e. typically less than 100 meters), and where a worldwide interoperability for microwave communications (WiMAX) network is an IEEE 802.16 network for providing long range wireless telecommunications services (i.e. typically several kilometers). In the embodiment shown in FIG. 3, a Radius, DIAMETER or SIP message may be used to authenticate and/or register a mobile subscriber in a network and may be received or intercepted by RSM 402 for generating AER message 418. It is appreciated that SIP signaling router (SSR)/call session control module (CSCF) 408 may be connected to one or more of HLR/HSS 416, SIP registrar server 414, and SIP location server 412. Thus, DIAMETER/Radius/SIP message 410 that is intercepted by RSM 402 may be addressed to one or more of databases 412-416.

Upon receiving AER message 418, RAE module 404 may communicate with roaming operators 420-424 for hosting one or more auctions, where bids may be received from operators 420-424 during the auction period. Bids 426-430 may be evaluated by RAE module 404 and network selection list information 432 may be determined. As described above, network selection list information 432 may prioritize (or otherwise order) networks 420-424 based on bids 426-430. In FIG. 3, network selection list information 432 indicates that operator 424 is the most preferred network, operator 422 is the next most preferred network, and operator 420 is the least preferred network. Network selection list information 432 may then be sent to DMM 406 for delivery to the mobile subscriber's handset. For example, DMM 406 may generate and send update message 434 to the mobile subscriber.

As stated above with respect to FIGS. 1 and 2, methods for providing dynamic roaming arbitrage service may be implemented in integrated or probe-based embodiments without departing from the scope of the subject matter described herein.

Once again, RSM 402 may infer general location information from the triggering authentication/registration message(s), or may request/obtain location information associated with a mobile subscriber (e.g., query a location server, query an HSS, query an HLR, directly query the mobile subscriber handset). RSM 402 may also obtain subscriber service profile information via, for example, an HSS/HLR query. Some or all of this information may be communicated to RAE module 404 for initiating and hosting an auction for the right to provide roaming service to the mobile subscriber from among one or more roaming service providers 420-424.

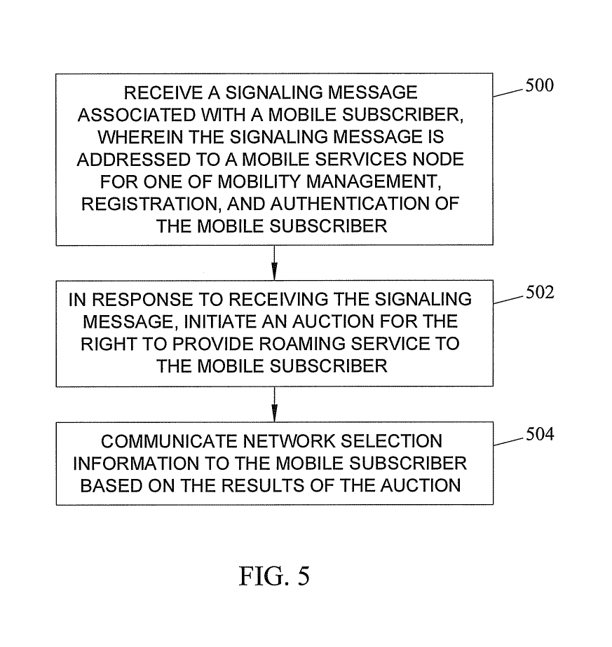

FIG. 5 is a flow chart of exemplary steps for providing dynamic roaming arbitrage service according to an embodiment of the subject matter described herein. Referring to FIG. 5, in block 500, a signaling message associated with a mobile subscriber is received, wherein the signaling message is addressed to a mobile services node for one of mobility management, registration, and authentication of the mobile subscriber.

In block 502, in response to receiving the signaling message, an auction is initiated for the right to provide roaming service to the mobile subscriber. For example, bids may be solicited and received from one or more roaming service providers. The bids may be associated with providing a specific roaming service and may be valid for a specified duration. Additionally, the bids may include a maximum and a minimum bid amount for the right to provide roaming service to the roaming mobile subscriber. In one embodiment, information may be provided to the roaming service providers relating to historical call statistics of the mobile subscriber so that roaming service providers may better tailor bids to a mobile subscriber.

In block 504, network selection information is communicated to the mobile subscriber based on the results of the auction. The network selection information may include a prioritized list of roaming network operators and may be stored, for example, on a SIM card associated with the mobile subscriber's handset. The network selection list may then be automatically consulted when determining which network to connect to while roaming.

It will be appreciated that various embodiments of the present invention may include an RSF that is integrated with/associated with/co-located with a mobile services node, such as an AAA server, an HLR node, an IMS HSS node, an IMS CSCF node, a SIP proxy node, or SIP registrar node.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for providing dynamic roaming arbitrage, the method comprising:
receiving a signaling message associated with a mobile subscriber, wherein the signaling message is addressed to a mobile services node for one of mobility management, registration, and authentication of the mobile subscriber;
in response to receiving the signaling message, initiating an auction for the right to provide roaming service to the mobile subscriber; and
communicating network selection information to the mobile subscriber based on the results of the auction.

2. The method of claim 1 wherein receiving the signaling message includes intercepting a signaling message.

3. The method of claim 1 wherein receiving the signaling message includes receiving one of a mobile application protocol (MAP) Update_Location message, a MAP Update_GPRS_location message, a MAP Send_Authentication_Info message, a MAP Insert_Subscriber_Data message, and a session initiation protocol (SIP) Register message.

4. The method of claim 1 wherein receiving the signaling message associated with the mobile subscriber includes receiving one of a universal mobile telecommunications system (UMTS) message, a session initiation protocol (SIP) message, an Internet multimedia subsystem (IMS) message, a next generation network (NGN) message, a WiFi message, a worldwide interoperability for microwave access (WiMax) message, a DIAMETER message, and a RADIUS message and an IEEE 802.xx message.

5. The method of claim 1 comprising hosting the auction.

6. The method of claim 1 wherein initiating an auction for the right to provide roaming service includes determining at least one of an international mobile subscriber identity (IMSI) value, a mobile switching center (MSC) address, a visitor location register (VLR) number, and a mobile subscriber integrated services digital network number (MSISDN).

7. The method of claim 1 wherein initiating an auction for the right to provide roaming service includes generating an arbitrage exchange registration (AER) message.

8. The method of claim 7 wherein generating the AER message includes generating an AER message including at least one of an international mobile station identifier (IMSI), a mobile subscriber integrated services digital network (MSISDN), a uniform resource identifier (URI), an Internet protocol address, a SIP contact address, and a temporary ID, wherein the temporary ID uniquely identifies the mobile subscriber.

9. The method of claim 1 wherein initiating an auction for the right to provide roaming service includes determining a network selection list of roaming service providers having the right to provide mobile service to the mobile subscriber, wherein the network selection list is prioritized from most preferred to least preferred.

10. The method of claim 1 wherein initiating an auction for the right to provide roaming service includes monitoring the status of the mobile subscriber.

11. The method of claim 10 wherein monitoring the status of the mobile subscriber includes generating one or more arbitrage exchange update (AEU) messages associated with one of the network status and location of the mobile subscriber.

12. The method of claim 1 wherein initiating an auction for the right to provide roaming service includes receiving one or more bids from one or more roaming service providers, wherein the one or more bids include at least one of a time for which the bid is valid, a minimum bid amount, and a maximum bid amount.

13. The method of claim 1 wherein initiating an auction for the right to provide roaming service includes hosting a plurality of auctions among a plurality of roaming service providers for the mobile subscriber, wherein each auction is associated with a different type of mobile service.

14. The method of claim 1 wherein communicating network selection information to the mobile subscriber includes communicating network selection information via one of an over the air (OTA) interface, a short message service (SMS) message, an unstructured supplementary service data (USSD) message, an Internet protocol message, and a session initiation protocol (SIP) message.

15. A method for providing dynamic roaming arbitrage, the method comprising:
receiving a signaling message from a communication device associated with a mobile subscriber;
determining that the mobile subscriber is roaming based on the signaling message;
in response to determining that the mobile subscriber is roaming, determining network selection information based on an auction among one or more roaming service providers; and
providing the network selection information to the mobile subscriber's communication device.

16. The method of claim 15 wherein receiving the signaling message includes intercepting a signaling destined for a mobile services node.

17. A method for providing dynamic roaming arbitrage, the method comprising:
receiving a signaling message from a communication device associated with a mobile subscriber;
receiving one or more bids for the right to provide roaming service to the mobile subscriber;
automatically determining network selection information based on the received signaling message and the one or more bids; and
providing the network selection information to the mobile subscriber's communication device.

18. The method of claim 17 wherein receiving the signaling message includes intercepting a signaling destined for a mobile services node.

19. A system for providing dynamic roaming arbitrage service, the system comprising:
a roaming screening module (RSM) for receiving a signaling message associated with a mobile subscriber, wherein the signaling message is addressed to a mobile services node for one of mobility management, registration, and authentication of the mobile subscriber; and
a roaming arbitrage exchange (RAE) module for initiating an auction for the right to provide roaming service to the mobile subscriber based on the received message and communicating network selection information to the mobile subscriber based on the results of the auction.

20. The system of claim 19 wherein receiving the signaling message includes intercepting a signaling message.

21. A system for providing dynamic roaming arbitrage service, the system comprising:
a roaming screening module (RSM) for receiving a signaling message from a communication device associated with a mobile subscriber; and
a roaming arbitrage exchange (RAE) module for determining that the mobile subscriber is roaming based on the signaling message and,
in response to determining that the mobile subscriber is roaming, determining network selection information based on an auction among one or more roaming service providers.

22. The system of claim 21 comprising a device manager function for providing the network selection information to the communication device.

23. A system for providing dynamic roaming arbitrage service, the system comprising:
a roaming screening module (RSM) for receiving a signaling message from a communication device associated with a mobile subscriber; and
a roaming arbitrage exchange (RAE) module for receiving one or more bids for the right to provide roaming service to the mobile subscriber and automatically determining network selection information based on the signaling message and the one or more bids.

24. The system of claim 23 comprising a device manager function for providing the network selection information to the communication device.

25. The system of claim 23 wherein the roaming screening module is configured to receive one of a mobile application protocol (MAP) Update_Location message, a MAP Update_GPRS_location message, a MAP Send_Authentication_Info message, a MAP Insert_Subscriber_Data message, and a session initiation protocol (SIP) Register message.

26. The system of claim 23 wherein the roaming screening module is configured to receive one of a universal mobile telecommunications system (UMTS) message, a session initiation protocol (SIP) message, a DIAMETER message, a RADIUS message, an Internet multimedia subsystem (IMS) message, a next generation network (NGN) message, a WiFi message, a worldwide interoperability for microwave access (WiMax) message, and an IEEE 802.xx message.

27. The system of claim 23 wherein the roaming arbitrage exchange module is configured to determine at least one of an international mobile subscriber identity (IMSI) value, a mobile switching center (MSC) address, a visitor location register (VLR) number, and a mobile subscriber integrated services digital network number (MSISDN).

28. The system of claim 23 wherein the roaming arbitrage exchange module is configured to generate an arbitrage exchange registration (AER) message.

29. The system of claim 28 wherein the AER message includes at least one of an international mobile subscriber identifier (IMSI), a mobile subscriber integrated services digital network number (MSISDN), an Internet protocol address, a uniform resource identifier, a SIP contact address, and a temporary ID, wherein the temporary ID uniquely identifies the mobile subscriber.

30. The system of claim 23 wherein the roaming arbitrage exchange module is configured to determine a network selection list of roaming service providers having the right to provide mobile service to the mobile subscriber, wherein the network selection list is prioritized from most preferred to least preferred.

31. The system of claim 23 wherein the roaming arbitrage exchange module is configured to monitor the status of the mobile subscriber.

32. The system of claim 23 wherein the roaming arbitrage exchange module is configured to generate one or more arbitrage exchange update (AEU) messages associated with one of the network status and location of the mobile subscriber.

33. The system of claim 23 wherein the roaming arbitrage exchange module is configured to receive one or more bids from one or more roaming service providers, wherein the one or more bids include at least one of a time for which the bid is valid, a minimum bid amount, and a maximum bid amount.

34. The system of claim 23 wherein the roaming arbitrage exchange module is configured to host a plurality of auctions among a plurality of roaming service providers for the mobile subscriber, wherein each auction is associated with a different type of mobile service.

35. The system of claim 23 wherein the roaming arbitrage exchange module is configured to communicate network selection information via one of an over the air (OTA) interface, a short message service (SMS) message, an Internet protocol message, a session initiation protocol (SIP) message, and an unstructured supplementary service data (USSD) message.

36. A system for providing dynamic roaming arbitrage, the system comprising:
a roaming screening module (RSM) for receiving a signaling message associated with a mobile subscriber; and
a roaming arbitrage exchange (RAE) module for determining that the mobile subscriber is roaming based on the signaling message and,
in response to determining that the mobile subscriber is roaming, determining network selection information based on an auction among one or more roaming service providers.

37. A system for providing dynamic roaming arbitrage, the system comprising:
a roaming screening module (RSM) for intercepting, at an intermediate signaling node, a signaling message associated with a mobile subscriber; and
a roaming arbitrage exchange (RAE) module for receiving one or more bids for the right to provide roaming service to the mobile subscriber and automatically determining network selection information based on the intercepted signaling message and the one or more bids.

38. A computer readable medium having stored thereon computer executable instructions that when executed by the processor of a computer perform steps comprising:
receiving a signaling message associated with a mobile subscriber, wherein the signaling message is addressed to a mobile services node for one of mobility management, registration, and authentication of the mobile subscriber;
in response to receiving the signaling message, initiating an auction for the right to provide roaming service to the mobile subscriber; and
communicating network selection information to the mobile subscriber based on the results of the auction.
